(19) United States
(12) Patent Application Publication
(10) Pub. No.: US 2025/0121868 A1
(43) Pub. Date: Apr. 17, 2025

(54) HAND TRUCK FOR TRANSPORTING COACHING EQUIPMENT OF A SPORTS TEAM

(71) Applicant: Louis Briand, Middle Sackville (CA)

(72) Inventor: Louis Briand, Middle Sackville (CA)

(21) Appl. No.: 18/905,328

(22) Filed: Oct. 3, 2024

(30) Foreign Application Priority Data
Oct. 13, 2023 (CA) 3216494

(51) Int. Cl. B62B 1/14; B62B 1/12

(52) U.S. Cl. CPC B62B 1/14; B62B 1/12; B62B 2202/40

(57) ABSTRACT

A hand truck comprising a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base.

### FIELD OF THE INVENTION

The present invention relates to hand carriers, and more particularly to a hand truck adapted for transporting coaching equipment of a sports team.

### BACKGROUND OF THE INVENTION

The coach of a sports team such as, for example, a hockey team, must carry a large assortment of equipment between a storage space, various transport vehicles, a sports arena, and an actual game or training area. For example, the assortment for a hockey coach may comprise water bottles, pucks, skate sharpener, helmet repair kit, tape roll, whistle, and a white board with markers and eraser, to name a few, which typically cannot be carried as a single load, thus requiring several trips or several people to carry the load.

Present-day hand carriers for coach equipment, typically of a four-wheel type, are difficult to handle, difficult to load, and awkward for transporting a white board. Furthermore, these carriers are complex in design, expensive to manufacture, and bulky when not in use.

It is desirable to provide a hand truck for transporting coaching equipment of a sports team that is easy to handle.

It is also desirable to provide a hand truck for transporting coaching equipment of a sports team that is easily and quickly loaded.

It is also desirable to provide a hand truck for transporting coaching equipment of a sports team that enables easy loading of a white board.

It is also desirable to provide a hand truck for transporting coaching equipment of a sports team that is easily and quickly assembled/disassembled and that is compact when disassembled.

It is also desirable to provide a hand truck for transporting coaching equipment of a sports team that is simple and cost-effective to manufacture.

### SUMMARY OF THE INVENTION

Accordingly, one object of the present invention is to provide a hand truck for transporting coaching equipment of a sports team that is easy to handle.

Another object of the present invention is to provide a hand truck for transporting coaching equipment of a sports team that is easily and quickly loaded.

Another object of the present invention is to provide a hand truck for transporting coaching equipment of a sports team that enables easy loading of a white board.

Another object of the present invention is to provide a hand truck for transporting coaching equipment of a sports team that is easily and quickly assembled/disassembled and that is compact when disassembled.

Another object of the present invention is to provide a hand truck for transporting coaching equipment of a sports team that is simple and cost-effective to manufacture.

According to one aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base.

According to the aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base. The lower securing structure comprises at least a hook adapted for being interfaced with a sidewall of the container through at least an opening disposed in the sidewall of the container.

According to the aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base. An upper securing structure is fixedly mounted to an upper portion of the support frame. The upper securing structure is adapted for securing a substantially flat item placed between the first container and the support frame. The upper securing structure comprises a first hook-and-loop fastener element adapted for interfacing with a corresponding second hook-and-loop fastener element disposed on the item.

According to the aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base. A top of the upper portion of the support frame is adapted to form a handlebar. The upper securing structure comprises at least a spacing element for holding the item a predetermined distance from the upper portion of the support frame.

According to the aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base. The support base is pivotally movable mounted to the lower portion of the support frame.

According to the aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base. The support base is pivotally movable mounted to the lower portion of the support frame. The upper portion of the support frame is pivotally movable mounted to the lower portion of the support frame.

According to the aspect of the present invention, there is provided a hand truck. The hand truck comprises a support base and a support frame mounted to the support base and oriented substantially perpendicular thereto. At least two wheels are mounted to the support base or the support frame. A lower securing structure is mounted to a lower portion of the support frame. The lower securing structure is adapted for securing a first container at a predetermined distance to the support frame when interfaced with the lower securing structure and placed onto the support base. The hand truck further comprises the first container. The first container is adapted for being placed onto the support base and interfaced with the lower securing structure. A sidewall of the container comprises at least an opening disposed therein. The at least an opening is adapted for being interfaced with the lower securing structure. The hand truck further comprises a second container adapted for being placed onto the first container. A bottom portion of the second container is adapted for being interfaced with a top portion of the first container for securely holding the second container while the hand truck is moved.

According to the aspect of the present invention, there is provided a method for transporting an assortment of items. A hand truck is provided. The hand truck comprises a support base and a support frame mounted to the support base and oriented substantially perpendicular thereto. At least two wheels are mounted to the support base or the support frame.

A lower securing structure is mounted to a lower portion of the support frame. The lower securing structure is adapted for securing a first container at a predetermined distance to the support frame when interfaced with the lower securing structure and placed onto the support base. A loaded first container is placed onto the support base such that the first container is interfaced with the lower securing structure. A substantially flat item is placed between the first container and the support frame. The substantially flat item is secured using an upper securing structure fixedly mounted to an upper portion of the support frame. A loaded second container is placed onto the first container. A bottom portion of the second container is interfaced with a top portion of the first container for securely holding the second container while the hand truck is moved.

The advantage of the present invention is that it provides a hand truck for transporting coaching equipment of a sports team that is easy to handle.

A further advantage of the present invention is that it provides a hand truck for transporting coaching equipment of a sports team that is easily and quickly loaded.

A further advantage of the present invention is that it provides a hand truck for transporting coaching equipment of a sports team that enables easy loading of a white board.

A further advantage of the present invention is that it provides a hand truck for transporting coaching equipment of a sports team that is easily and quickly assembled/disassembled and that is compact when disassembled.

A further advantage of the present invention is that it provides a hand truck for transporting coaching equipment of a sports team that is simple and cost-effective to manufacture.

### BRIEF DESCRIPTION OF THE DRAWINGS

A preferred embodiment of the present invention is described below with reference to the accompanying drawings, in which:

FIGS. 1 to 3 are simplified block diagrams illustrating in a perspective view, a front view, and a side view, respectively, a hand truck according to a preferred embodiment of the invention;

FIG. 4 is a simplified block diagram illustrating in a perspective view dimensions of the hand truck according to the preferred embodiment of the invention;

FIGS. 5 and 6 are simplified block diagrams illustrating in perspective views collapsing and a collapsed state, respectively, of the hand truck according to the preferred embodiment of the invention;

FIGS. 7 to 9 are simplified block diagrams illustrating in a front view, a top view, and a detailed top perspective view, respectively, the first container interfaced with the lower securing structure of the hand truck according to the preferred embodiment of the invention;

FIG. 10 is a simplified block diagram illustrating in a bottom perspective view a second container for use with the hand truck according to the preferred embodiment of the invention;

FIGS. 11 and 12 are simplified block diagrams illustrating in a front perspective view and a side view, respectively, the hand truck according to the preferred embodiment of the invention with two containers;

FIG. 13 is a simplified block diagram illustrating in a top perspective view a hand truck according to another preferred embodiment of the invention;

FIGS. 14 and 15 are simplified block diagrams illustrating in top perspective views two different upper securing structures of the hand truck according to the preferred embodiment of the invention; and,

FIG. 16 is a simplified block diagram illustrating in a side perspective view a stair climbing wheel structure for use with the hand truck according to the preferred embodiments of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The present invention relates to an L-shaped hand carrier with a handle at a top end and wheels at a base thereof, also called a hand cart, a dolly cart, or a hand truck. For definition, “hand truck” will be used for the remainder of this document.

While the description of the preferred embodiments hereinbelow is with reference to a hand truck for transporting coaching equipment of a hockey team, it will become evident to those skilled in the art that the embodiments of the invention are not limited thereto, but are also adaptable for coaches of various other sports teams such as, for example, roller hockey, ringette, lacrosse, etc., as well as for transporting equipment for other purposes than sports. Furthermore, while the hand truck described comprises two wheels, it may contain more than two wheels such as, for example, six wheels (three wheels on each side) for facilitating climbing stairs or a curb, as will be described hereinbelow.

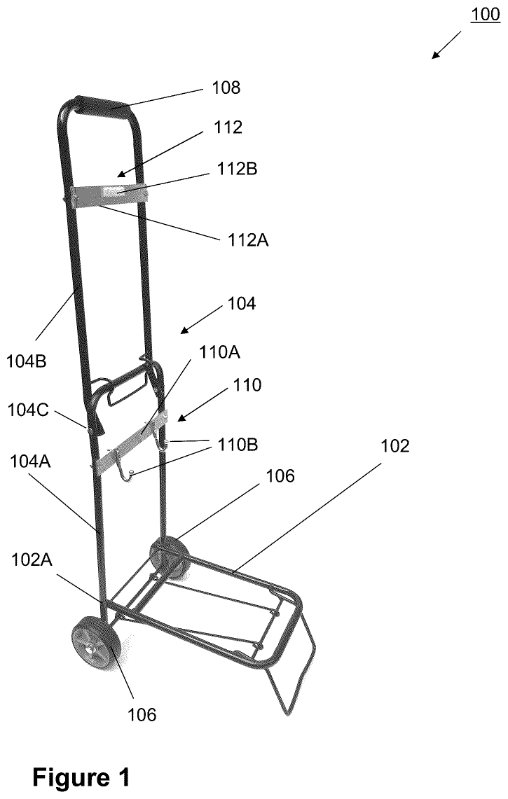

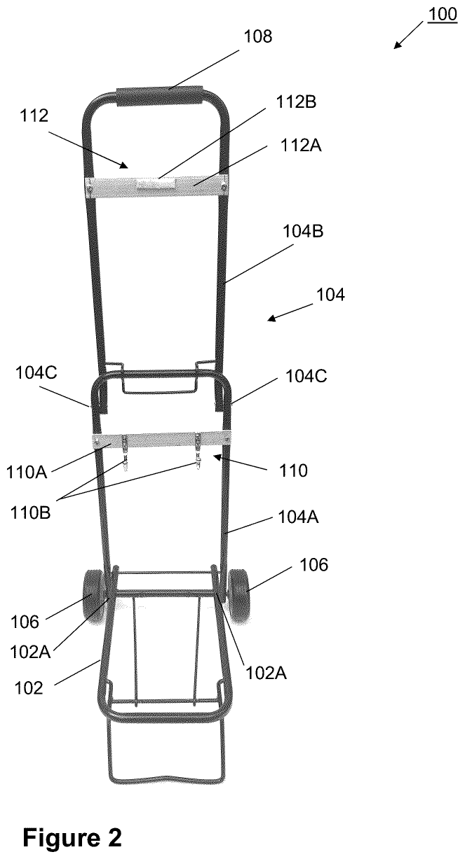

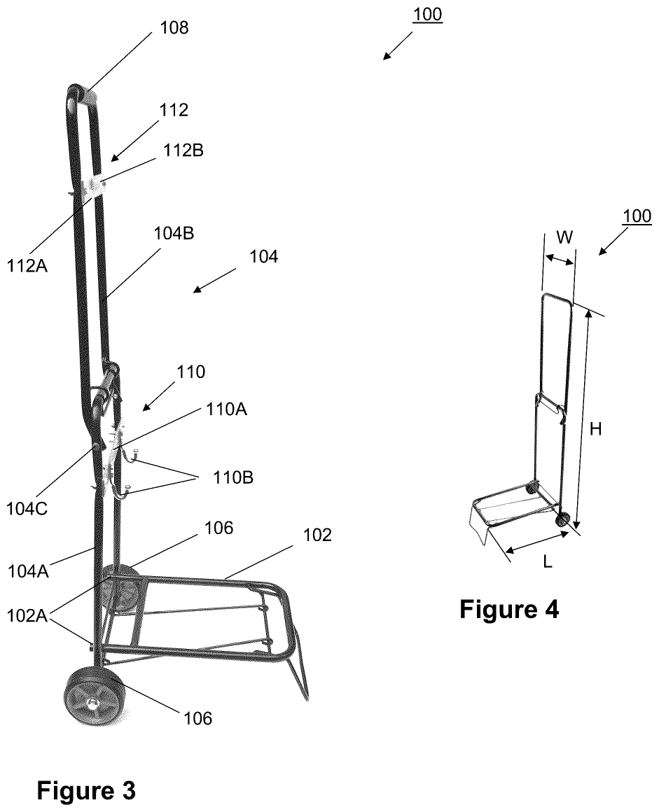

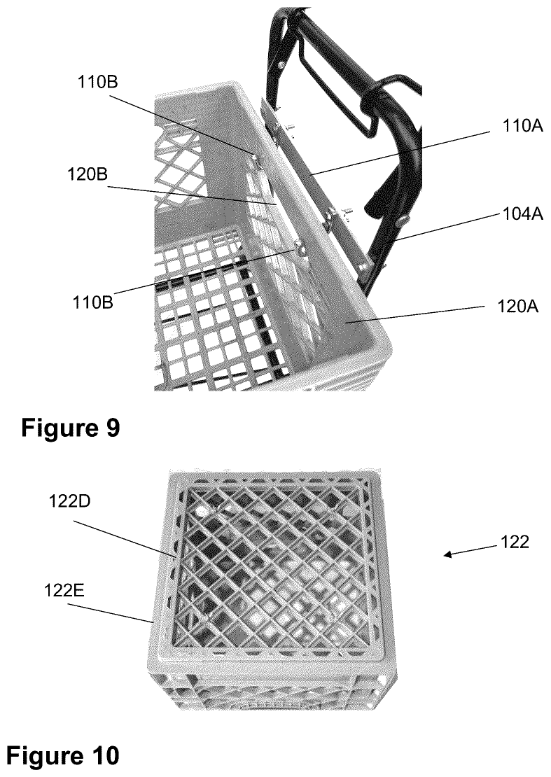

Referring to FIGS. 1 to 12 a hand truck 100 according to a preferred embodiment of the invention is provided. The hand truck 100 comprises a support base 102 and a support frame 104 mounted thereto such that the support frame 104 is oriented substantially perpendicular to the support base 102. Wheels 106 are rotatably movable mounted to one of the support frame 104 or the support base 102, depending on design preferences, at a location in proximity to a bottom end of the support frame 104 and a proximal end of the support base 102. For example, two wheels 106 are employed such that a first wheel is mounted to the left hand side and a second wheel is mounted to the right hand side. Alternatively, each of the two wheels 106 is replaced by a stair climbing mechanism comprising a substantially triangular wheel mounting structure 406A which is rotatably movable about axis 406B and has three wheels 406C.1, 406C.2, and 406C.3 rotatably movable mounted thereto, as illustrated in FIG. 16.

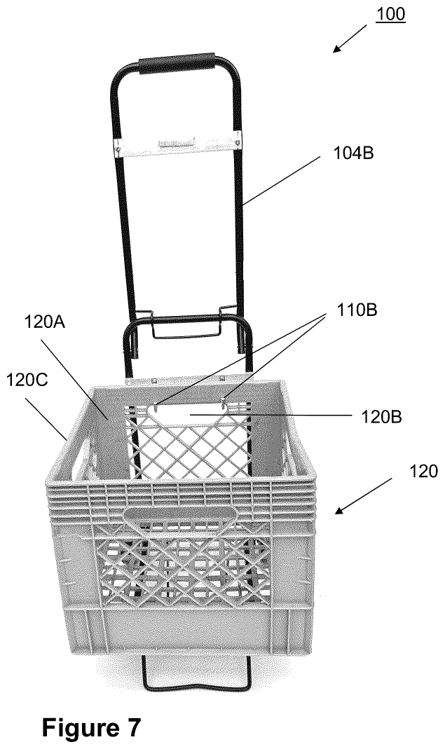

A lower securing structure 110 is mounted to a lower portion 104A of the support frame 104, as illustrated in FIGS. 1 to 3. The lower securing structure 110 secures a first container 120 at a predetermined distance D to the lower portion 104A of the support frame 104 when the first container 120 is interfaced with the lower securing structure 110 and placed onto the support base 102, as illustrated in FIGS. 7 to 9.

Preferably, the lower securing structure 110 comprises a connecting strip 110A having at least a hook 110B, preferably two hooks 110B, mounted thereto. The hooks 110B are adapted for being interfaced with a sidewall 120A of the container 120 through at least an opening 120B disposed therein. As is evident to a person skilled in the art, the hooks 106 may be provided having various shapes ranging from substantially U-shaped to a shape having a substantially straight first portion extending from the connecting strip 110A and oriented substantially parallel to the support base 102 and a second portion facing upwardly from a distal end of the first portion. Alternatively, the container 120 comprises securing elements such as, for example, rings, mounted to the outside of the sidewall 120A which are adapted for being interfaced with the hooks 106.

In an example implementation, the connecting strip 110A is made of aluminum sheet material, but may also be made of other material such as, for example, steel sheet material, plastic material, or composite material. The hooks 110B are, preferably, off-the-shelf hooks mounted to the connecting strip 110A in a conventional manner such as for example, screw fastening or welding. The connecting strip 110A is mounted to the lower portion 104A of the support frame 104 in a conventional manner such as, for example, clamping, screw fastening or welding.

Further preferably, upper securing structure 112 is mounted to an upper portion 104B of the support frame 104, as illustrated in FIGS. 1 to 3. The upper securing structure 112 is adapted for securing a substantially flat item 10 such as, for example, a whiteboard, placed between the first container 120 and the support frame 104, as illustrated in FIG. 12. The upper securing structure 112, preferably, comprises a connecting strip 112A having a first hook-and-loop fastener element 112B mounted thereto. The first hook-and-loop fastener element 112B is adapted for interfacing with a corresponding second hook-and-loop fastener element disposed on the item 10, for example, adhered thereto.

In the example implementation, the connecting strip 112A is made of aluminum sheet material, but may also be made of other material such as, for example, steel sheet material, plastic material, or composite material. The first hook-and-loop fastener element 112B is, preferably, an off-the-shelf hook-and-loop fastener mounted to the connecting strip 110A in a conventional manner such as for example, adhering. The connecting strip 112A is mounted to the upper portion 104B of the support frame 104 in a conventional manner such as, for example, clamping, screw fastening or welding.

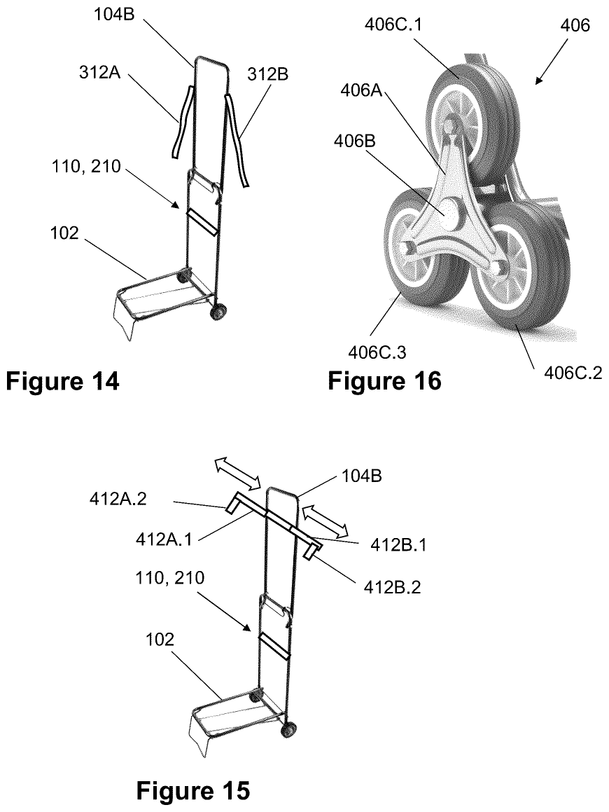

Alternatively, as illustrated in FIG. 14, the upper securing structure 112 is replaced by straps 312A and 312B made of, for example, a fabric material, which can be tied around the item 10 and secured together using a hook-and-loop fastener or a buckle.

Further alternatively, as illustrated in FIG. 15, the upper securing structure 112 may be replaced by telescopically movable arms 412A.1 and 412B.1, as indicated by the block arrows, with respective interacting elements 412A.2 and 412B.2 mounted to distal ends of the arms 412A.1 and 412B.1 for securing the item 10. For example, the telescopically movable arms 412A.1 and 412B.1 may be spring-loaded for enabling simple extension by pulling the arms while the spring-load ensures that the interacting elements 412A.2 and 412B.2 are in contact with the item 10 when the same is placed therebetween.

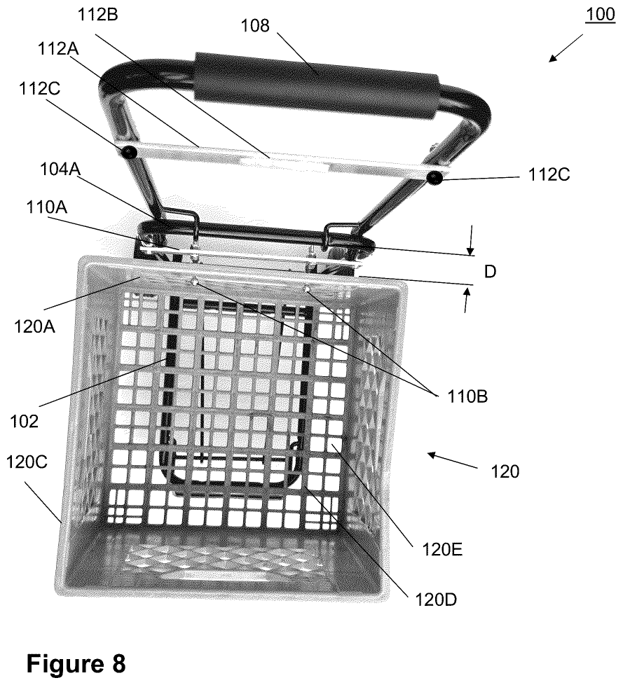

Optionally, the upper securing structure 112 further comprises at least a spacing element 112C for holding the item 10 a predetermined distance from the upper portion 104B of the support frame 104, as illustrated in FIG. 8. The spacing elements 112C are made of, for example, a plastic material or rubber material and are mounted to the connecting strip 112A in a conventional manner such as, for example, screw fastening or adhering. The spacing elements 112C keep the item 10 a predetermined distance from a top end of the upper portion 104B of the support frame 104. The employment of the spacing elements 112C is advantageous when the top of the upper portion 104B of the support frame 104 is adapted to form a handlebar 108 and the item 10 is kept a sufficient distance for a user to place a hand between the item 10 and the handlebar 108, thus enabling the user to grip and hold the handlebar 108 without having to push the item 10 from the handlebar 108. Of course, the spacing elements 112C may also be employed when the handlebar is provided such that the same extends rearwardly from the upper portion 104B of the support frame 104, or when a handlebar is provided extending rearwardly from each, a left hand and a right hand, side of the upper portion 104B of the support frame 104, for protecting the item 10 from getting damaged by preventing the same from getting into contact with the top of the upper portion 104B of the support frame 104.

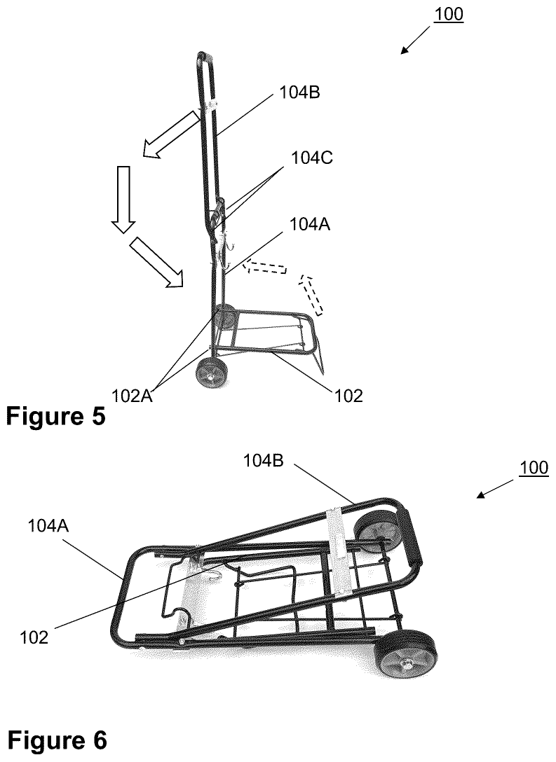

Further preferably, the proximal end 102A of the support base 102 is pivotally movable mounted to the lower portion 104A of the support frame 104, as indicated by the dashed block arrows in FIG. 5, thus enabling simple collapsing of the hand truck 100 to reduce the space required for storing the same when not in use.

Further preferably, the upper portion 104B of the support frame 104 is movably mounted to the lower portion 104A of the support frame 104 to further reduce the space required for storing the hand truck 100 when not in use. For example, the upper portion 104B of the support frame 104 is pivotally movably mounted to the lower portion 104A of the support frame 104, as indicated by the block arrows in FIG. 5, resulting in a compactly folded state of the hand truck 100, as illustrated in FIG. 6. Alternatively, the support frame 104 may be provided such that the upper portion 104B can be telescopically extended from the lower portion 104A.

In the example implementation, a commercially available hand truck comprising the lower portion 104A, the upper portion 104B, the support base 102, and wheels 106 is employed, as illustrated in FIG. 4, with the hand truck having the following dimensions: length L being approximately 30 cm; height H being approximately 90 cm; and width W being approximately 20 cm.

Further preferably, a second container 122 is adapted for being placed onto the first container 120. A bottom portion 122D of the second container 122 is, preferably, adapted for being interfaced with a top 120C of the first container 120 for securely holding the second container 122 while the hand truck 100 is moved. For example, the bottom portion 122D is surrounded by a recess 122E such that the bottom portion 122D is placed inside the top 120C while the recess 122E is in contact with the top 120C of the first container 120, as illustrated in FIGS. 8 and 10.

Further preferably, the bottom 120D of the first container 120 comprises openings 120E, or is provided as a lattice structure, to enable release of water therethrough in case wet equipment such as, for example, hockey pucks, are stored therein.

In the example implementation, commercially available crates made of plastic material such as, for example, milk crates, are employed as the first container 120 and the second container 122.

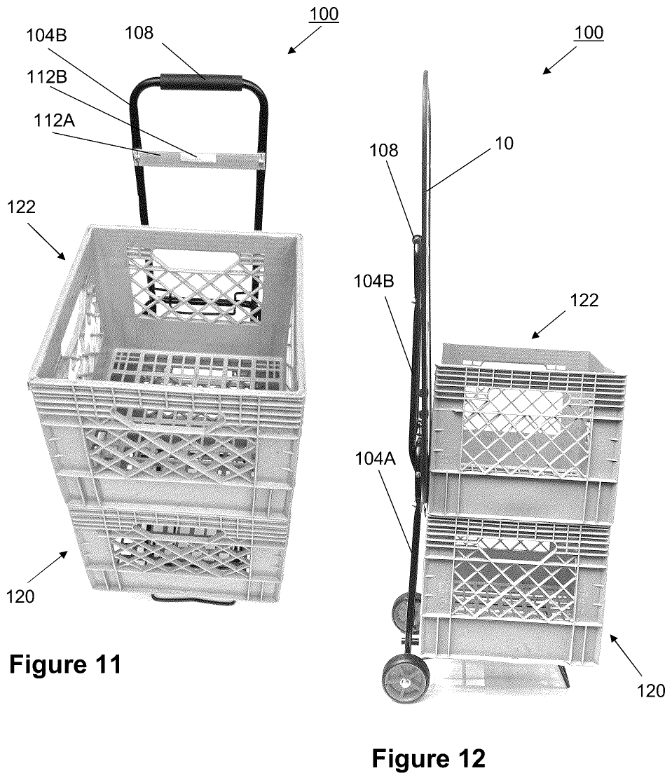

For use, the hand truck 100 is easily unfolded from the collapsed state, illustrated in FIG. 6, to the deployed state, illustrated in FIGS. 1 to 3, by reversing the process illustrated in FIG. 5. The loaded first container 120 is then placed onto the support base 102 such that the first container 120 is interfaced with the lower securing structure 110, as illustrated in FIG. 7. It is noted that the containers 120 and 122 are shown empty in the Figures for simplicity. After the first container 120 is securely placed onto the support base 102, the substantially flat item 10 can be placed between the first container 120 and the support frame 104 and secured to the upper securing structure 112. The loaded second container 122 can be placed onto the first container 120 such that the bottom 122D, 122E of the second container 122 is interfaced with the top 120C of the first container 120 for securely holding the second container 122 while the hand truck 100 is moved, as illustrated in FIG. 11. The flat item 10 may also be placed between the first container 120 and the support frame 104 and secured to the upper securing structure 112 after placement of the second container 122, as illustrated in FIG. 12. Optionally, a third container (not shown) or a sports bag may be placed on top of the second container 122.

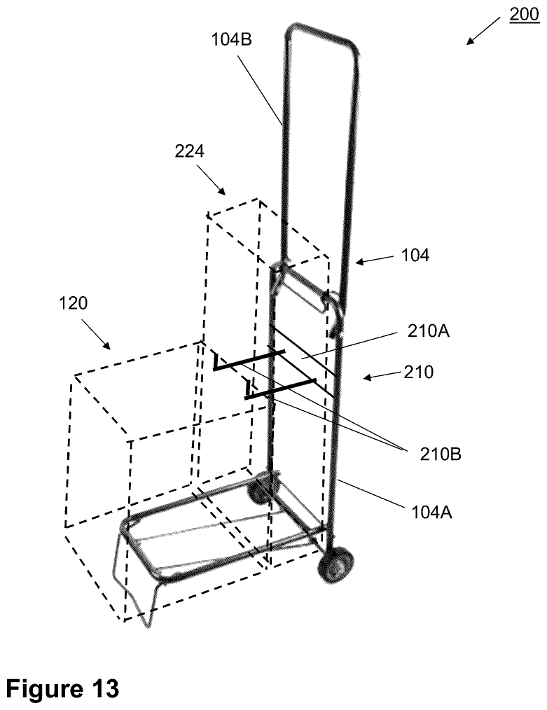

Referring to FIG. 13, a hand truck 200 according to another preferred embodiment of the invention is provided. Here, the lower securing structure 210 comprises connecting strip 210A having elongated hooks 210B mounted thereto. The hooks 210B are adapted for reaching through openings disposed in a front and rear wall of intermediate container 224 and for being interfaced with the sidewall 120A of the container 120 through at least an opening 120B disposed therein, as described hereinabove. Furthermore, the hooks 210B are adapted such that there is a predetermined distance between the rear wall of the intermediate container 224 and the support frame 104 for placing the item 10 therebetween. The intermediate container 224 extends a substantially shorter distance from the support frame 104 than the first container 120 but may be taller for securely containing elongated equipment such as hockey sticks, ringette sticks, or lacrosse sticks.

The present invention has been described herein with regard to preferred embodiments. However, it will be obvious to persons skilled in the art that a number of variations and modifications can be made without departing from the scope of the invention as described herein.

What is claimed is:

1. A hand truck comprising:
a support base;
a support frame mounted to the support base and oriented substantially perpendicular thereto;
at least two wheels mounted to the support base or the support frame; and,
a lower securing structure mounted to a lower portion of the support frame, the lower securing structure being adapted for securing a first container at a predetermined distance to the support frame when interfaced with the lower securing structure and placed onto the support base.

2. The hand truck according to claim 1 wherein the lower securing structure is adapted for being interfaced with a sidewall of the container through at least an opening disposed in the sidewall of the container.

3. The hand truck according to claim 2 wherein the lower securing structure comprises at least a hook.

4. The hand truck according to claim 1 comprising an upper securing structure fixedly mounted to an upper portion of the support frame, the upper securing structure being adapted for securing a substantially flat item placed between the first container and the support frame.

5. The hand truck according to claim 1 wherein the upper securing structure comprises at least a spacing element for holding the item a predetermined distance from the upper portion of the support frame.

6. The hand truck according to claim 1 wherein the upper securing structure comprises a first hook-and-loop fastener element adapted for interfacing with a corresponding second hook- and -loop fastener element disposed on the item.

7. The hand truck according to claim 5 wherein a top of the upper portion of the support frame is adapted to form a handlebar.

8. The hand truck according to claim 1 wherein the upper portion of the support frame is movable mounted to the lower portion of the support frame.

9. The hand truck according to claim 1 wherein the upper portion of the support frame is pivotally movable mounted to the lower portion of the support frame.

10. The hand truck according to claim 1 wherein the support base is pivotally movable mounted to the lower portion of the support frame.

11. The hand truck according to claim 10 wherein the support base is pivotally movable mounted to the lower portion of the support frame.

12. The hand truck according to claim 1 comprising the first container, the first container being adapted for being placed onto the support base and interfaced with the lower securing structure.

13. The hand truck according to claim 12 wherein a sidewall of the container comprises at least an opening disposed therein, the at least an opening being adapted for being interfaced with the lower securing structure.

14. The hand truck according to claim 12 comprising a second container adapted for being placed onto the first container.

15. The hand truck according to claim 14 wherein a bottom portion of the second container is adapted for being interfaced with a top portion of the first container for securely holding the second container while the hand truck is moved.

16. A method for transporting an assortment of items comprising:
providing a hand truck comprising:
a. a support base;
b. a support frame mounted to the support base and oriented substantially perpendicular thereto;
c. at least two wheels mounted to the support base or the support frame; and,
d. a lower securing structure fixedly mounted to a lower portion of the support frame, the lower securing structure being adapted for securing a first container at a predetermined distance to the support frame when interfaced with the lower securing structure and placed onto the support base;
providing a first container;
loading the first container; and,
placing the first container onto the support base such that the first container is interfaced with the lower securing structure.

17. The method according to claim 16 comprising placing a substantially flat item between the first container and the support frame.

18. The method according to claim 17 comprising securing the substantially flat item using an upper securing structure fixedly mounted to an upper portion of the support frame.

19. The method according to claim 18 comprising:
providing a second container;
loading the second container; and,
placing the second container onto the first container.

20. The method according to claim 19 interfacing a bottom portion of the second container with a top portion of the first container for securely holding the second container while the hand truck is moved.
